(19) United States
(12) Patent Application Publication
(10) Pub. No.: US 2010/0304583 A1
(43) Pub. Date: Dec. 2, 2010

(54) DISTRIBUTION FRAME MODULE

(75) Inventor: Ralf-Dieter Busse, Hoppegarten (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/739,622

(22) PCT Filed: Oct. 13, 2008
(86) PCT No.: PCT/EP2008/008632

§ 371 Date: Apr. 23, 2010

(30) Foreign Application Priority Data
Oct. 23, 2007 (DE) 10 2007 050 590.8

(51) Int. Cl. H01R 13/60

(52) U.S. Cl. 439/76.1

(57) ABSTRACT

The invention relates to a distribution frame module (40) for use in telecommunication and data system engineering, comprising a housing (2) in which input contacts and output contacts, accessible from the exterior, for connecting lines and wires are arranged, the housing (2) being configured to have a space in which at least one printed circuit board (80) is arranged. At least the input contacts are configured by at least one PCB connector (1), said PCB connector (1) comprising contact elements (3). Said contact elements (3) have a contact for connecting wires and lines and a contact for contacting the printed circuit board (80). The housing (2) has at least two lateral parts (4), the PCB connector (1) being configured to have at least one interface each side for snap-locking into the lateral parts (65, 66) of the housing (60).

The invention relates to a distribution board connection module for telecommunications and data technology.

DE 103 39 844 B3 has disclosed a distribution board connection module for telecommunications and data technology, comprising a housing, in which input and output contacts for connecting lines and wires are arranged in such a way that they are accessible from the outside, the housing being formed with a cavity, in which at least one printed circuit board is arranged, the input and output contacts being arranged on the opposite end sides of the housing, the input contacts being in the form of at least one terminal strip with insulation displacement contacts, the input and output contacts being releasably connected to the printed circuit board, the terminal strip bearing the input contacts being releasably connected to the housing via a front panel part, the insulation displacement contacts being connected to the printed circuit board via fork contacts and the connection between the front panel part and the housing being designed such that, when the connection is released, the terminal strip, which is connected to the front panel part, is moved away from the printed circuit board with the fork contacts, the housing being formed with a stop, the printed circuit board, in the inserted state, lying with its end side associated with the input contacts behind the stop.

The invention is based on the technical problem of providing a distribution board connection module which makes a higher packing density of the contacts possible.

The solution to the technical problem results from the subject matters having the features of claim 1. Further advantageous configurations of the invention result from the dependent claims.

In this regard, the distribution board connection module for telecommunications and data technology comprises a housing, in which input and output contacts for connecting lines and wires are arranged in such a way that they are accessible from the outside, the housing being formed with a cavity, in which at least one printed circuit board is arranged, at least the input contacts being formed by at least one plug-type printed circuit board connector, the plug-type printed circuit board connector comprising contact elements, the contact elements having a contact for connecting wires and lines and a contact for making contact with the printed circuit board, and the housing having at least two side parts, the plug-type printed circuit board connector being formed laterally with in each case at least one interface for latching onto the side parts of the housing. As a result, it is possible to dispense with the front panel parts, so that the packing density is increased and, at the same time, the replacement of the printed circuit boards is simplified.

Preferably, the housing of the plug-type printed circuit board connector is designed to be integral, the contact elements being latched captively in the housing. This results in a simple and compact design of the plug-type printed circuit board connector since the housing can be produced, for example, in one method step using injection-molding technology. As a result, necessary physical specifications for latching or the like to housing parts in order to plug together the housing no longer need to be adhered to.

Further preferably, the housing of the plug-type printed circuit board connector has slots on the upper side and the lower side, into which slots enlarged portions of the contact elements engage. Since the housing is produced from plastic, it has a certain spring action, so that, when the contact elements are inserted, they are loaded slightly, but bend the plastic of the housing away until the enlarged portions latch into the slots. Instead of the slots, the housing may also have projections, behind which the contact elements latch in when inserted. Preferably, the enlarged portions are arranged on the contact for connecting the printed circuit board. In a design with projections, said projections are preferably arranged in such a way that the contact for connecting the wires latches behind the projection.

In a further preferred embodiment, the contact for connecting the wires is in the form of an insulation displacement contact and/or the contact for connecting the printed circuit board is in the form of a fork contact.

In a further preferred embodiment, the insulation displacement contact is rotated through 45° with respect to the fork contact, the rotation taking place about the longitudinal axis of the contact element.

The interfaces on the housing of the plug-type printed circuit board connector for latching onto the side parts of the housing of the distribution board connection module are either an integral part of the housing of the plug-type printed circuit board connector or else separate component parts. The former has the advantage of saving on one fitting step and a reduction in the component parts. The design as a separate component part, on the other hand, increases the flexibility in order to match the plug-type printed circuit board connector to different housings of distribution board connection modules.

In a further preferred embodiment, connecting elements are therefore arranged on the side faces of the housing of the plug-type printed circuit board connector, on which connecting elements side parts are arranged, which have an interface for connection to the module housing. In this case, the side parts can be designed differently depending on the application. In principle, it is also possible to connect further housings with contact elements to the connecting elements, so as to provide the possibility of a modularly extendable plug-type printed circuit board connector.

Preferably, the interface for connection to a module housing is arranged on the outer sides of the side parts of the plug-type printed circuit board connector.

In a further preferred embodiment, the interface comprises a ramp-shaped element, above and below which in each case one latching element is arranged, the latching elements being flatter than the highest elevation of the ramp-shaped element. As a result, the highest elevation of the ramp-shaped element forms a defined pressure point, which juts out when inserted into a module housing, so that, as a result of pressure on the ramp-shaped elements, the interfaces are pressed inwards and unlatch the latching elements.

In a further preferred embodiment, the connecting elements on the side faces of the housing are in the form of a drilled hole with a lateral slot, the width of the slot being smaller than the diameter of the drilled hole.

In this case, the corresponding connecting elements on the side parts are in the form of cylinder pins, which have a larger circular head. For connection purposes, the head is then plugged through the drilled hole and subsequently the cylinder pin moved in the slot, which results in a type of locking via the head part. In principle, however, other embodiments for the connecting elements are also conceivable, for example simple holes, into which journals are plugged.

In a further preferred embodiment, a cover, which is at right angles to the upper side, is arranged on the upper side of the housing. The cover is primarily used as a mechanical protection means for electrical functional elements arranged, for example, on the printed circuit board.

The electrical functional elements on the printed circuit board preferably lie electrically between the input and output contacts, the functional elements further preferably being XDSL modules.

As an alternative or in addition, surge protection elements are arranged on the printed circuit board.

In a further preferred embodiment, the housing of the distribution board connection module is made from metal. In addition to the increased mechanical stability, this simplifies a connection to ground, in particular if functional elements are arranged on the printed circuit board which require a connection to ground, such as surge protection elements, for example.

In a further preferred embodiment, at least one ground contact, which is electrically connected to the printed circuit board, is therefore arranged on inner sides of the side parts of the housing of the distribution board connection module. Since preferably a plurality of printed circuit boards are arranged one above the other in the housing, a contact comb is preferably used, which is designed to be integral and has ground contacts corresponding to the number of printed circuit boards. Preferably, a ground contact or contact comb is arranged on each side part, so that the ground currents can be distributed more effectively and furthermore a redundant connection to ground is realized.

In a further preferred embodiment, the housing of the distribution board connection module is designed to be integral.

Preferably, the housing of the distribution board connection module comprises an upper part, a rear wall and a lower part, which are designed to be integral, the side parts being welded to the upper and/or lower part.

In a further preferred embodiment, clamping fastenings are arranged on the outer sides of the side parts, by means of which clamping fastenings the connection module can be fastened to bay-type rails, the clamping fastening having a clamping limb, which can be actuated from the front side.

In a further preferred embodiment, at least one plug-type connector for cables is arranged on the rear side of the housing of the distribution board connection module, which plug-type connector forms the output contacts. The plug-type connector is further preferably in the form of a D-sub plug-type connector.

In a further preferred embodiment, a backplane is arranged on the inner side of the rear wall of the housing and has the at least one plug-type connector for cables, which plug-type connector is passed to the outside through an opening in the rear wall of the housing, the backplane having plug-type connectors, which are connected to plug-type connectors on the printed circuit board(s) and to the plug-type connector(s) for cables.

The invention will be explained in more detail below with reference to a preferred exemplary embodiment. In the figures:

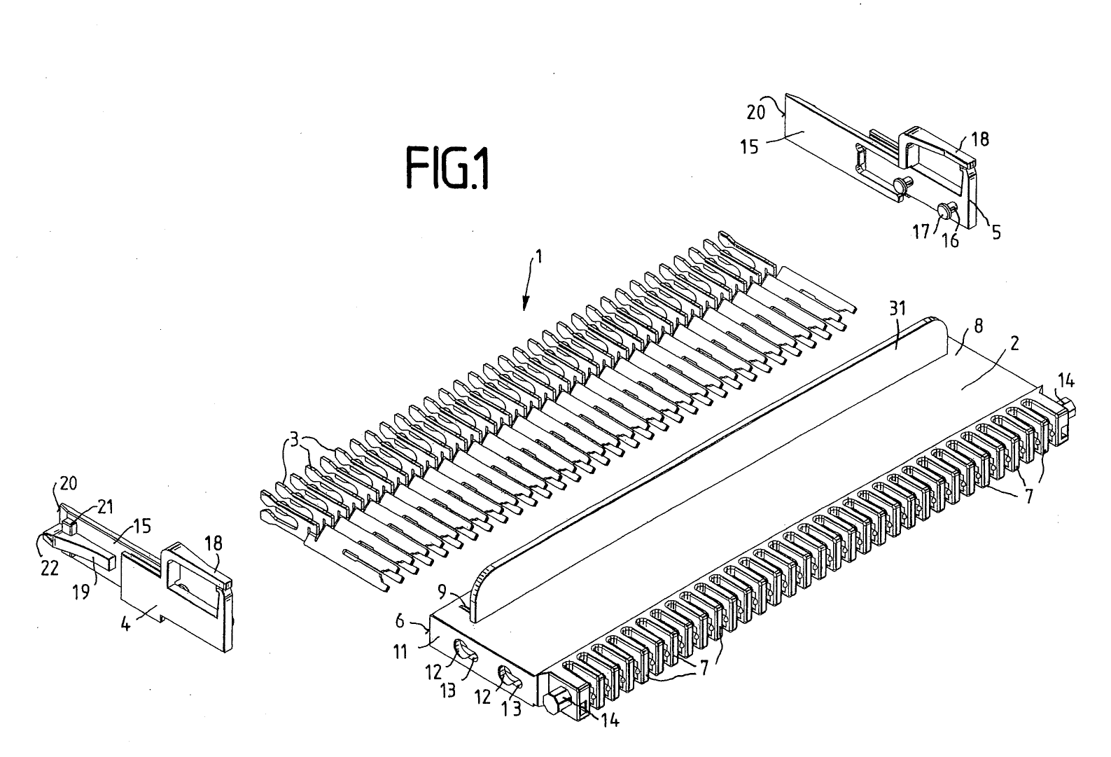

FIG. 1 shows an exploded illustration of a plug-type printed circuit board connector,

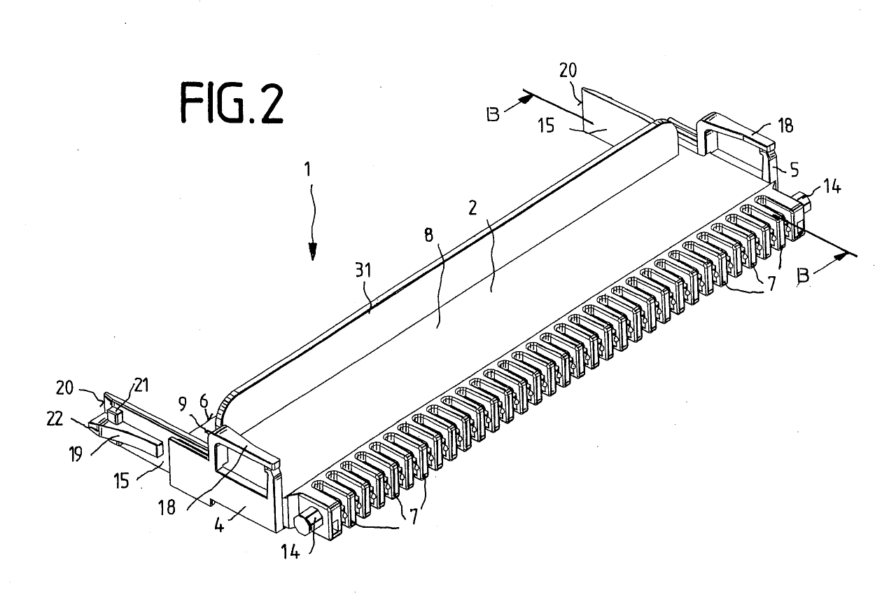

FIG. 2 shows a perspective plan view of an assembled plug-type printed circuit board connector,

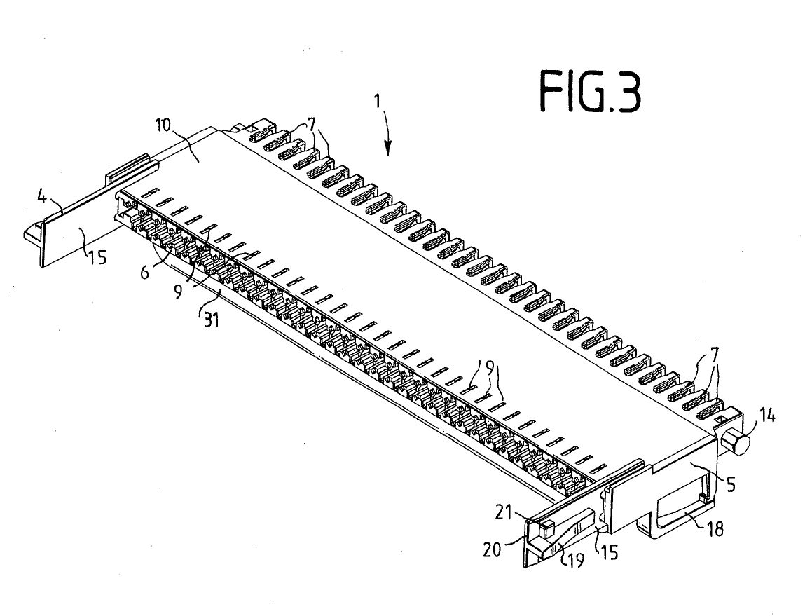

FIG. 3 shows a perspective view from below of the plug-type printed circuit board connector,

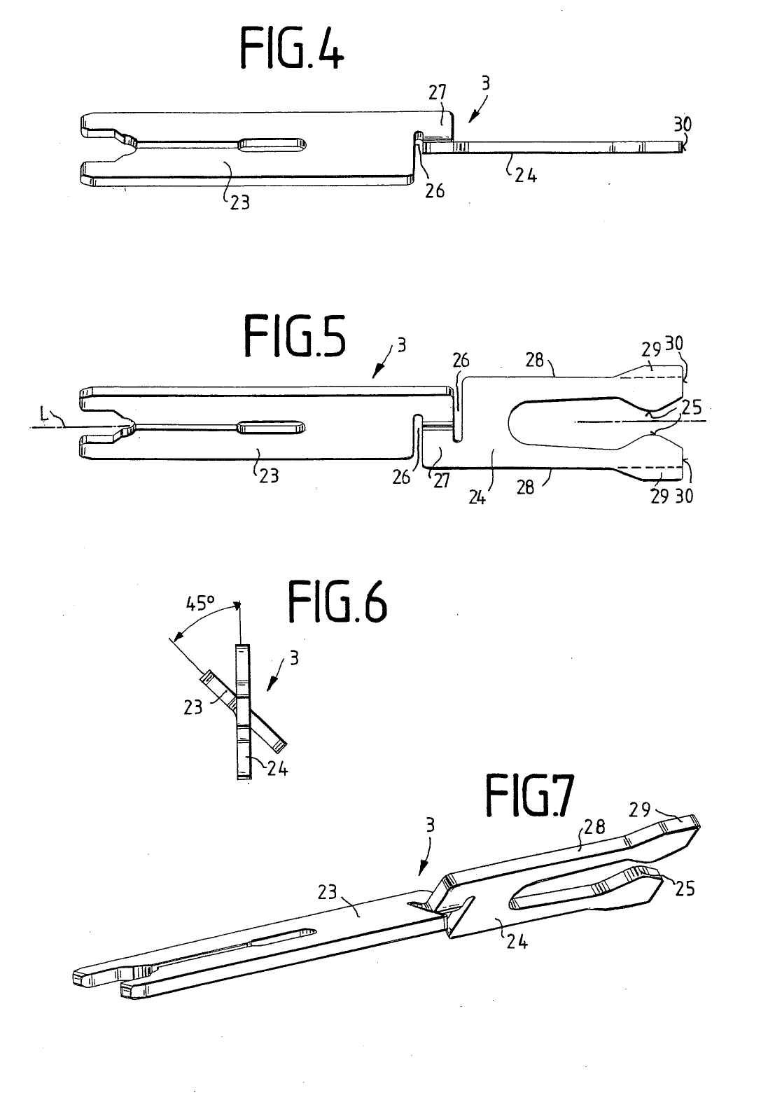

FIG. 4 shows a first perspective side view of a contact element,

FIG. 5 shows a second perspective side view of the contact element,

FIG. 6 shows a plan view of the contact element,

FIG. 7 shows a third perspective side view,

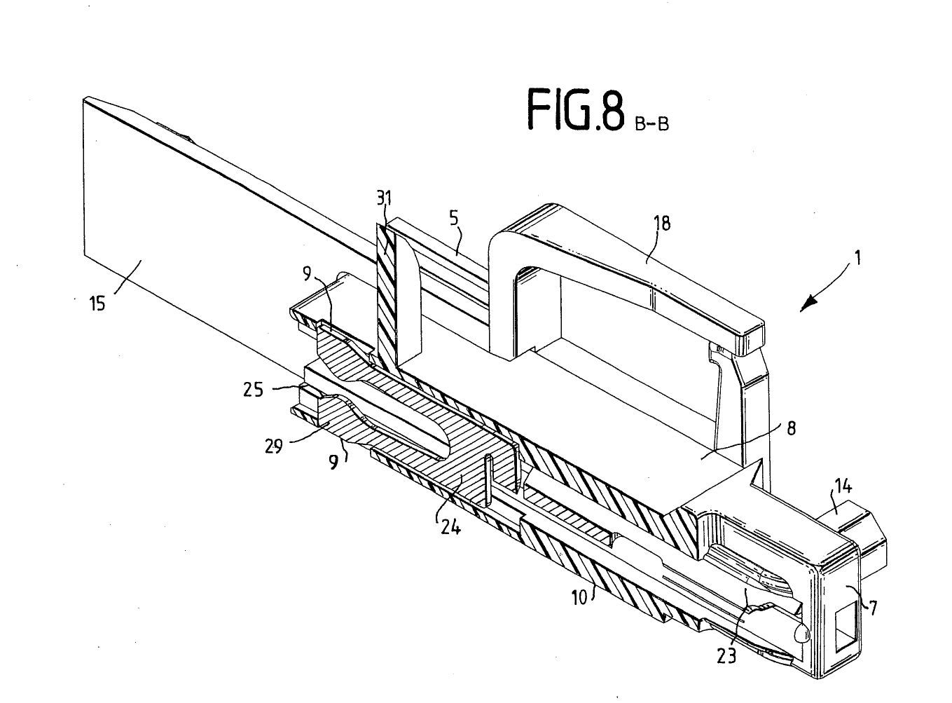

FIG. 8 shows a sectional illustration through the plug-type printed circuit board connector along the section B-B,

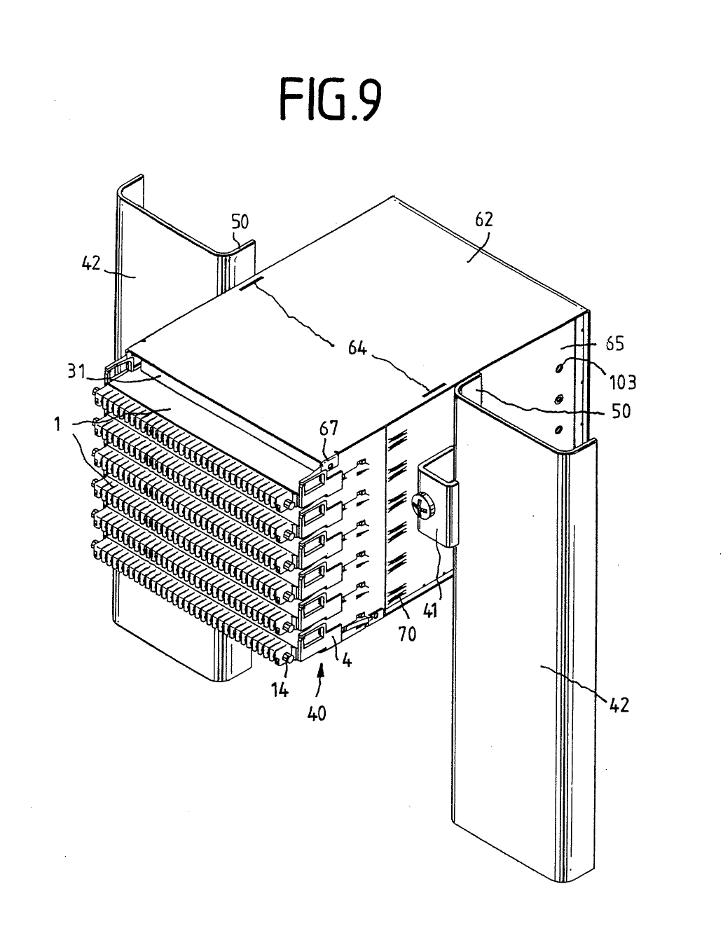

FIG. 9 shows a perspective front view of a distribution board connection module,

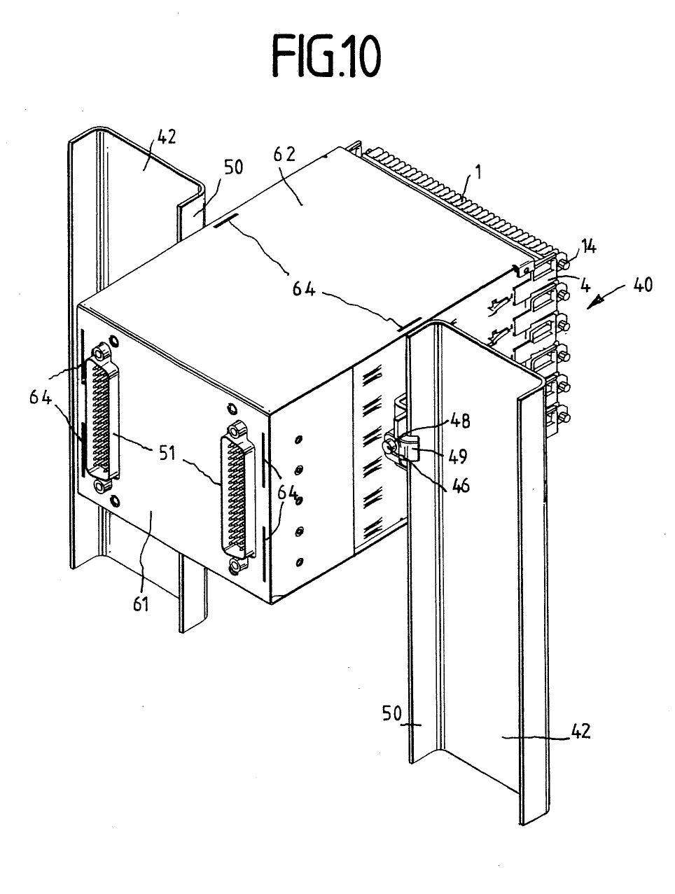

FIG. 10 shows a perspective rear view of the distribution board connection module,

FIG. 11 shows a plan view of the distribution board connection module,

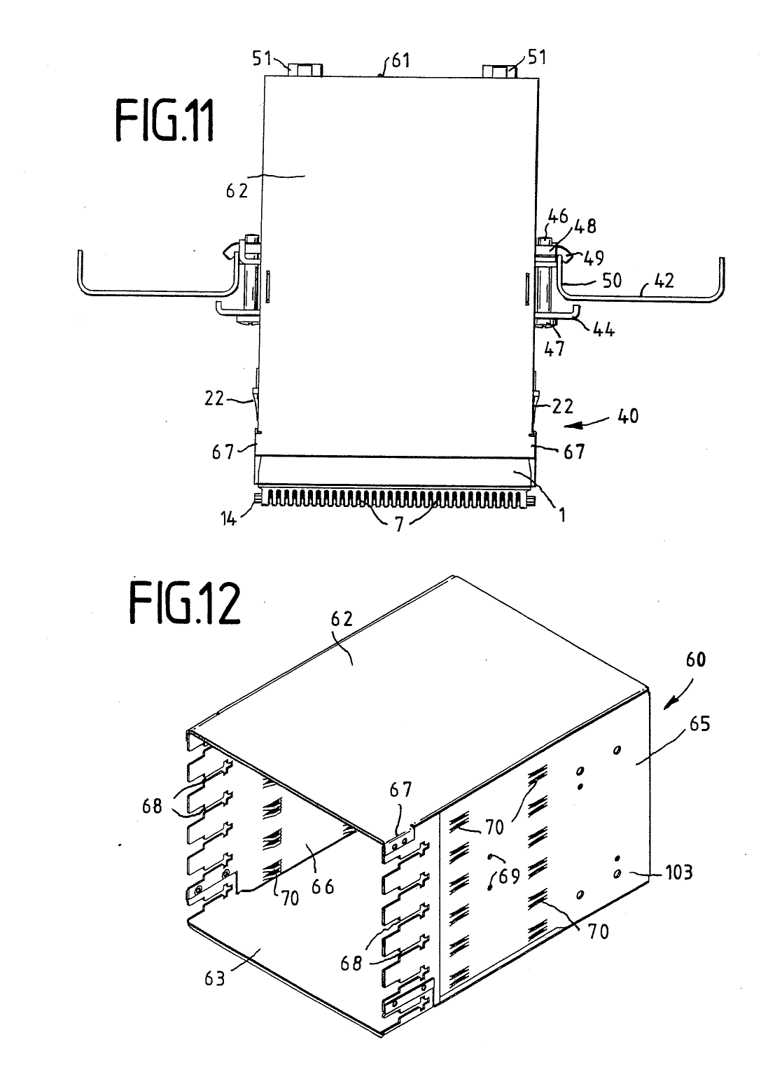

FIG. 12 shows a perspective illustration of the housing of the distribution board connection module,

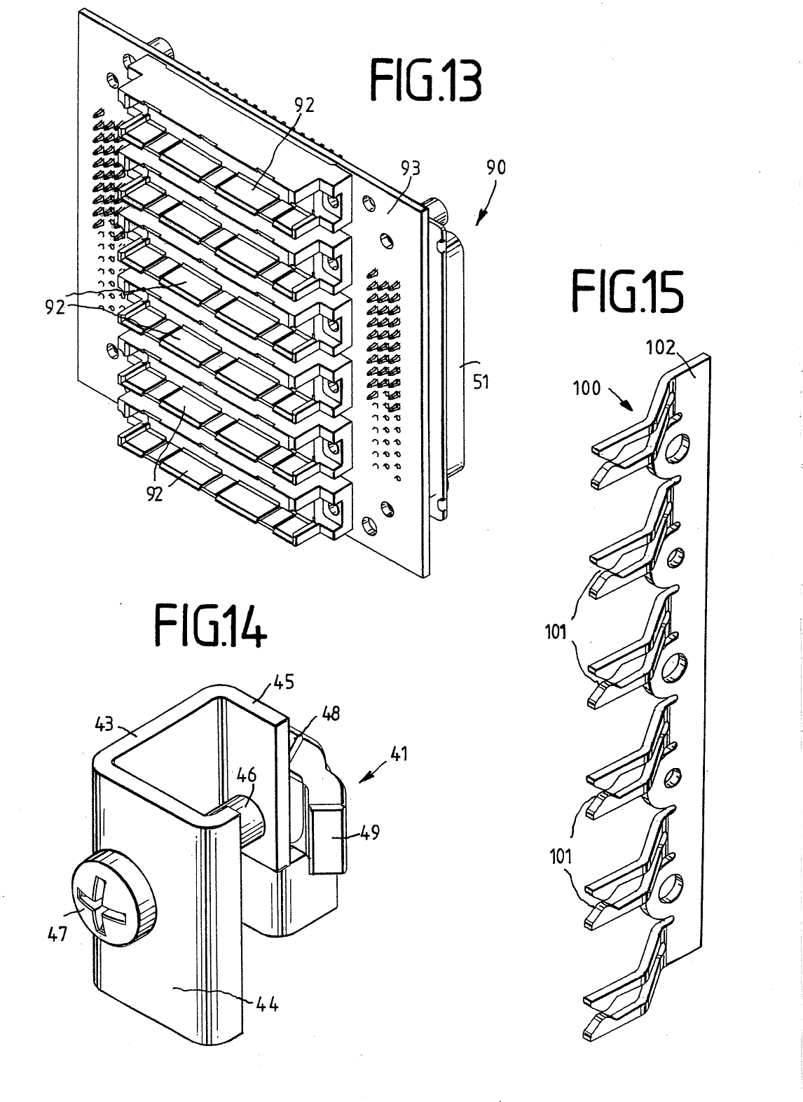

FIG. 13 shows a perspective illustration of a backplane,

FIG. 14 shows a perspective illustration of a clamping fastening,

FIG. 15 shows a perspective illustration of a contact comb, and

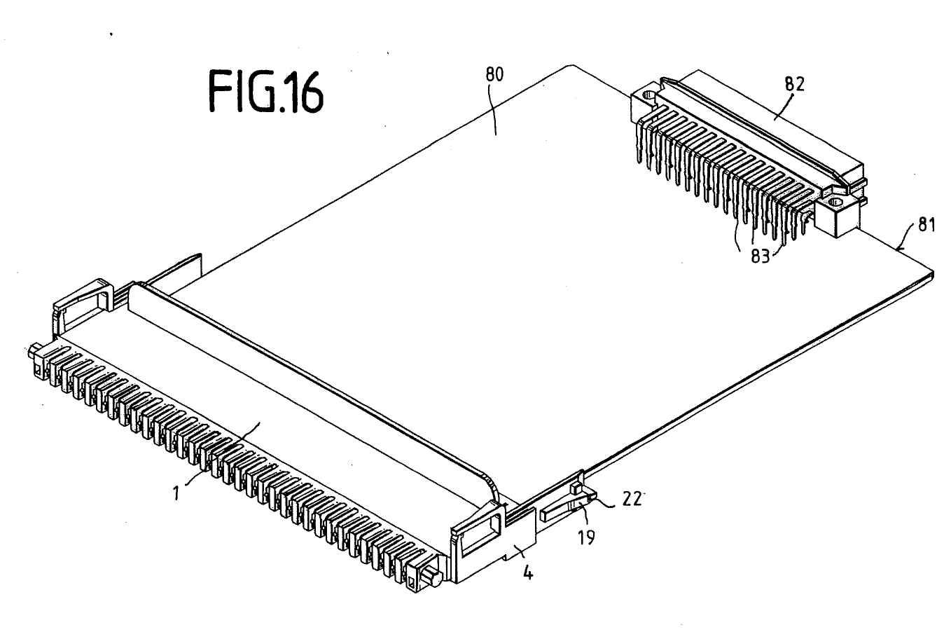

FIG. 16 shows a perspective illustration of a printed circuit board with a plug-type printed circuit board connector and a plug-type connector.

The plug-type printed circuit board connector 1 comprises an integral housing 2 made from plastic, a number of contact elements 3 and two side parts 4, 5. The housing 2 is formed in the interior with guides (not illustrated), in which the contact elements 3 are guided in a defined manner. The housing 2 is formed in terms of its depth in such a way that the contact elements 3 are completely accommodated (see also FIG. 8). For this purpose, the contact elements 3 are pushed into the housing 2 from the lower, open end side 6. Domes 7 are arranged on the upper end side of the housing 2, between which domes 7 the contact elements 3 lie. A cover 31, which extends virtually over the full width of the housing 2 and is arranged at right angles to the upper side 8, is arranged on an upper side 8 of the housing 2. Slots 9 are incorporated into the housing 2 on the upper side 8 and a lower side 10 (see FIG. 3) of the housing 2. The number of slots 9 in the upper side 8 or lower side 10 corresponds to the number of contact elements 3. In the example illustrated, the housing 2 is used for accommodating thirty-two contact elements 3. The slots 9 in the upper side 8 are in this case aligned with the slots 9 in the lower side 10. Drilled holes 12 with a lateral slot 13 are arranged on the side faces 11 of the housing 2. In this case, the width of the slot 13 is slightly smaller than the diameter of the drilled hole 12. Furthermore, pin-shaped elements 14, which have a hexagonal cross section and are used as pivot bearings of a nameplate frame (not illustrated), are arranged on the side faces 11 or the outer sides of the two last domes 7. The side parts 4, 5 each have a lug-shaped basic body 15. In each case two pin-shaped elements 16 with a wider, circular head part 17 are arranged on the inner sides of the lug-shaped basic body 15. In order to connect the side parts 4, 5 to the housing 2, the head parts 17 are plugged into the drilled hole 12 and then the side part 4, 5 moved in the direction of the domes 7, the pin-shaped elements 16 running along in the slot 13. The head part 17 which lies behind this and is wider than the slot 13 then prevents the side part 4, 5 from being able to be withdrawn. The side parts 4, 5 furthermore have a cable guide 18, whose geometry can be matched to the requirements in situ. The plug-type printed circuit board connector 1 can therefore be matched optimally to the conditions by using various side parts 4, 5. A ramp-shaped element 19, which extends as far as an end side 20 of the lug-shaped basic body 15, which end side 20 is opposite the cable guide 18, is arranged on the outer sides of the lug-shaped basic body 15. In each case one latching element 21, which is designed to be parallelepipedal in the example illustrated, is arranged above and below the ramp-shaped element 19. In this case, the latching element 21 is flatter than the highest elevation 22 of the ramp-shaped element 19 and further preferably also not higher than any point on the ramp-shaped element 19.

The contact element 3 will now be explained in more detail with reference to FIGS. 4 to 7. The integral contact element 3 comprises an insulation displacement contact 23 for connecting wires and a fork contact 24 for connection to a printed circuit board. In this case, contact regions 25 of the fork contact 24 make contact with metallized pads on the printed circuit board. In the longitudinal direction L, the fork contact 24 and the insulation displacement contact 23 are rotated through 45° with respect to one another, which can best be seen in FIG. 6. For this purpose, the contact element 3 has notches 26, which results in a flexible web 27. The fork contact 24 has enlarged portions 29 on the outer sides 28 thereof, which enlarged portions lie at the level of the contact regions 25 and extend as far as the end side 30 of the fork contact 24. When the contact element 3 is inserted into the housing 2, the enlarged portions 29 slide into the slots 9 of the upper side 8 and lower side 10, so that the contact elements 3 are latched captively in the housing 2. This latched state can best be seen in FIG. 8.

FIGS. 9 to 11 illustrate the distribution board connection module 40 with six plug-type printed circuit board connectors 1, the distribution board connection module 40 being fastened to two bay-type rails 42 by means of two clamping fastenings 41. The clamping fastening 41 comprises a substantially U-shaped basic body 43, the front limb 44 being slightly longer than the rear limb 45, and having an inwardly pointing bent-back portion (see FIG. 14). A rotatably mounted pin 46, on whose front side a screw head 47 is arranged, is guided through the two limbs 44, 45. At the rear end, a clamping limb 48 is arranged which has an arcuate bent-back portion 49, which, in the fitted state, engages behind a limb 50 of the bay-type rail 42. As can be seen in particular in FIG. 9, the clamping limb 48 with the arcuate bent-back portion 49 can be actuated from the front side via the screw head 47. As can be seen in particular in FIG. 11, the two clamping fastenings 41 have an identical design, but are fastened to the distribution board connection module 40 in such a way that they are rotated with respect to one another. As is illustrated in FIG. 10, two plug-type connectors 51 for cables are arranged on a rear wall 61 of the housing 60 of the distribution board connection module 40, which plug-type connectors 51 are in the form of D-sub plug-type connectors. The plug-type connectors 51 are in this case guided through openings in the rear wall 61. The housing 60 comprises an upper part 62, a lower part 63 and the rear wall 61, which are designed to be integral. The housing 60 has slots 64 on the upper part 62, the lower part 63 and the rear wall 61, into which two side parts 65, 66 are plugged. Two lugs 67, which engage over the side parts 65, 66 and are used to weld the side parts 65, 66 to the upper part 62, are arranged on the upper part 62. The finished integral housing 60 made from metal is illustrated in FIG. 12. Furthermore, the two side parts 65, 66 have slots 68, which are in the form of a cross at the back and accommodate the latching elements 21 of the plug-type printed circuit board connector 1. At the front, the slots 68 are designed to be wider, which facilitates the insertion process. The clamping fastenings 41 are riveted to the side parts 65, 66 via connection points 69. Furthermore, the side parts 65, 66 have guides 70 for the printed circuit boards 80 (see FIG. 16). For this purpose, the side parts 65, 66 are provided with notches and bent inwards.

A backplane 90 is fastened to the inner side of the rear wall 61. The two plug-type connectors 51 for cables, which are connected to plug-type connectors 92 on the front side 93 of the backplane 90 via conductor tracks, are arranged on the rear side of the backplane 90. In this case, in each case one plug-type connector 92 is associated with a printed circuit board 80, on whose respective rear-side end side 81 a plug-type connector 82 is arranged, which forms an electrical plug-type connection with a plug-type connector 92. The assignment between the plug-type connectors 92 and the plug-type connectors 51 is in this case preferably such that in each case three plug-type connectors 92 are wired to a plug-type connector 51. Before the electrical functionality of a preferred embodiment is now explained in more detail, the production of a connection to ground should briefly be explained beforehand if such a connection to ground is required. For this purpose, an integral contact comb 100 is fastened, preferably riveted, to each side part 65, 66 of the housing 60 on the inner side, the contact comb 100 having six ground contacts 101, which are in the form of fork contacts. The ground contacts 101 are bent back slightly from a basic rail 102, so that, when the printed circuit board 80 is inserted into the housing 60, the printed circuit board 80 safely makes contact with the ground contact 101. For this purpose, the housing 60 has contact points 103 for the riveting.

In a preferred embodiment, XDSL component parts are arranged on the printed circuit board 80, the plug-type printed circuit board connectors 1 forming the input contacts for ISDN/POTS and subscriber line and the plug-type connectors 51 forming the output contacts for the DSLAM. In this case, note should be made of the fact that the flow of data is bidirectional and therefore the term input and output contacts is only used for orientation purposes. The plug-type printed circuit board connectors 1 each have thirty-two contact elements 3 and can therefore connect sixteen twin wires. In this case, preferably the left-hand insulation displacement contacts are used for the ISDN/POTS lines and the right-hand insulation displacement contacts are used for subscriber lines. Therefore 8-DA-ISDN/POTS and 8-DA subscriber lines are connected by means of a plug-type printed circuit board connector. These lines are led via conductor tracks (not illustrated) on the printed circuit board 80 to the XDSL components, 8-DA-DSLAM conductor tracks being led from the XDSL component to the plug-type connector 82. Said plug-type connector 82 therefore has at least sixteen pins 83, via which the plug-type connector 82 is connected to the conductor tracks and therefore to the outputs of the XDSL components. If the plug-type connector 82 has more pins 83, sixteen pins 83 are selected, these preferably having a distance from one another which is as great as possible. If the plug-type connector 82 has, for example, 3×8 pins 83, the central row is left free, for example. As a result, crosstalk (NEXT) is reduced. Then, the 8-DA-DSLAM lines are led to the plug-type connector 51 via the plug-type connector 92. In the case of six printed circuit boards 80, a 48×DA-XDSL splitter module can therefore be realized by the distribution board connection module.

In applications where all of the lines are intended to be connected from the front side, the backplane 90 can be dispensed with. In this case, the distribution takes place entirely on the plug-type printed circuit board connector 1, where three times five DA lines (5-DA-POTS; 5-DA line, 5-DA-DSLAM) are connected. Then, a contact element is not connected between two groups of 5×DA lines. In this case, a front-side 30-DA-XDSL splitter module (6 printed circuit boards×5 DA) is realized.

As a result of the novel plug-type printed circuit board connectors 1, the distribution board connection module can be realized with a physical height of 87.5 mm, which corresponds to half the physical height of a 100-DA termination, i.e. a 96-DA splitter module can be made available which only requires the physical space of a conventional 100-DA termination. Note is also made of the fact that the distance between the limbs of the bay-type rails is preferably between 120 and 122 mm, the limb length preferably being between 15 and 17.5 mm.

As a result of the novel clamping latching, the individual printed circuit boards 80 can be replaced easily, so that defective printed circuit boards 80 can be removed easily or else the distribution board connection module 40 can be converted easily, for example from ADSL to VDSL.

### LIST OF REFERENCE SYMBOLS

1 Plug-type printed circuit board connector
2 Housing
3 Contact elements
4, 5 Side parts
6 End side
7 Domes
8 Upper side
9 Slots
10 Lower side
11 Side faces
12 Drilled holes
13 Lateral slot
14 Pin-shaped elements
15 Lug-shaped basic body
16 Pin-shaped elements
17 Head part
18 Cable guide
19 Ramp-shaped element
20 Opposite end side
21 Latching element
22 Highest elevation
23 Insulation displacement contact
24 Fork contact
25 Contact regions
26 Notches
27 Web
28 Outer sides
29 Enlarged portions
30 End side
31 Cover
40 Distribution board connection module
41 Clamping fastenings
42 Bay-type rails
43 U-shaped basic body
44, 45 Limbs
46 Pin
47 Screw head
48 Clamping limb
49 Arcuate bent-back portion
50 Limb
51 Plug-type connector
30 Housing
61 Rear wall
62 Upper part
63 Lower part
64 Slots
65, 66 Side parts
67 Lugs
68 Slots
69 Connection points
70 Guides
80 Printed circuit boards
81 End side
82 Plug-type connector
83 Pins
90 Backplane
92 Plug-type connector
93 Front side
100 Contact comb
101 Ground contacts
102 Basic rail
103 Contact points

1. A distribution board connection module for telecommunications and data technology, comprising:
a housing, in which input and output contacts for connecting lines and wires are arranged in such a way that they are accessible from the outside, the housing being formed with a cavity, in which at least one printed circuit board is arranged, at least the input contacts being formed by at least one plug-type printed circuit board connector, the plug-type printed circuit board connector comprising contact elements, the contact elements having a contact for connecting wires and lines and a contact for making contact with the printed circuit board, and the housing having at least two side parts, wherein the plug-type printed circuit board connector is formed laterally with in each case at least one interface for latching onto the side parts of the housing.

2. The distribution board connection module as claimed in claim 1, wherein electrical functional elements are arranged on the printed circuit board, which functional elements lie between the input and output contacts.

3. The distribution board connection module as claimed in claim 2, wherein the functional elements are in the form of XDSL modules.

4. The distribution board connection module as claimed in claim 1, wherein surge protection elements are arranged on the printed circuit board.

5. The distribution board connection module as claimed in claim 1, wherein the housing is made from metal.

6. The distribution board connection module as claimed in claim 5, wherein at least one ground contact, which is electrically connected to the printed circuit board, is arranged on the inner sides of the side parts of the housing.

7. The distribution board connection module as claimed in claim 1, wherein the housing is designed to be integral.

8. The distribution board connection module as claimed in claim 7, wherein the housing comprises an upper part, a rear wall and a lower part, which are designed to be integral, the side parts being welded to the upper and/or lower part.

9. The distribution board connection module as claimed in claim 1, wherein clamping fastenings are arranged on the outer sides of the side parts wherein the connection module can be fastened to bay-type rails, the clamping fastening having a clamping limb, which can be actuated from the front side.

10. The distribution board connection module as claimed in claim 1, wherein at least one plug-type connector for cables is arranged on the rear side of the housing.

11. The distribution board connection module as claimed in claim 10, wherein a plurality of printed circuit boards are arranged in the cavity of the housing, a backplane is arranged on the inner side of the rear wall of the housing and has the at least one plug-type connector for cables, which plug-type connector is passed to the outside through an opening in the rear wall of the housing, the backplane having plug-type connectors, which are connected to plug-type connectors on the printed circuit boards and to the plug-type connector for cables.
